(19) United States
(12) Patent Application Publication
(10) Pub. No.: US 2009/0043936 A1
(43) Pub. Date: Feb. 12, 2009

(54) DOCKING STATION AND EXPANDABLE COMPUTER SYSTEM

(75) Inventors: Cheng-Hung YANG, Taipei (TW); Kuei-Kang Chang, Taipei (TW); Chi-Chun Chen, Taipei (TW); Wan-Shan Lin, Taipei (TW); Wen-Chi Kuo, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/138,974

(22) Filed: Jun. 13, 2008

(30) Foreign Application Priority Data
Aug. 9, 2007 (TW) 096129461

(51) Int. Cl. G06F 13/00

(52) U.S. Cl. 710/304

(57) ABSTRACT

A docking station is used for cooperating with a computer host, and the computer host has a first power connecting portion and a first peripheral component connecting portion. The docking station includes a casing, a second power connecting portion and a second peripheral component connecting portion. The casing is used for disposing the computer host. The second power connecting portion and the second peripheral component connecting portion are disposed at the casing. When the computer host is disposed at the casing, the second power connecting portion is connected to the first power connecting portion to transmit a power signal to the computer host, and the second peripheral component connecting portion is connected to the first peripheral component connecting portion to transmit at least one peripheral component signal to the computer host. An expandable computer system is also disclosed.

### CROSS REFERENCE TO RELATED APPLICATIONS

This Non-provisional application claims priority under 35 U.S.C. §119(a) on Patent Application No(s). 096129461 filed in Taiwan, Republic of China on Aug. 9, 2007, the entire contents of which are hereby incorporated by reference.

### BACKGROUND OF THE INVENTION

1. Field of Invention

The invention relates to a docking station and an expandable system and, more particularly, to a docking station and an expandable computer system.

2. Related Art

Along with the development of the science and technology, a computer has been an essential electronic product in daily life. At present, each family almost has a computer mostly including a screen and a computer host. A plurality of connecting ports are exposed outside the casing of the computer host, and they are used for connecting peripheral devices such as a mouse, a keyboard, an earphone and a power wire.

Recently, an electronic product having a computer host with a small volume appears. As shown in FIG. 1, a conventional computer host 2 with a small volume is light, slim, short and small, and it has a fashionable appearance. However, since the computer host 2 is too small to have enough space to be used, the number of connecting ports 21 is not enough, which causes the trouble in usage.

Furthermore, the computer host 2 is deficient in mobility. When a user wants to use the computer host 2 in another place, he or she needs to move the computer host 2 with the peripheral devices such as a mouse, a keyboard, an earphone and a power wire, which cause the user the inconvenience.

### SUMMARY OF THE INVENTION

The objective of the invention is to provide a docking station and an expandable computer system for expanding connecting ports and enhancing mobility.

To achieve the above objective of the invention, a docking station of the invention is used to cooperate with a computer host, and the computer host has a first power connecting portion and a first peripheral component connecting portion. The docking station includes a casing, a second power connecting portion and a second peripheral component connecting portion. The casing is used for disposing the computer host. The second power connecting portion and the second peripheral component connecting portion are disposed at the casing. When the computer host is disposed at the casing, the second power connecting portion is electrically connected to the first power connecting portion to transmit a power signal to the computer host, and the second peripheral component connecting portion is electrically connected to the first peripheral component connecting portion to transmit at least a peripheral component signal to the computer host or receive the peripheral component signal from the computer host.

To achieve the above objective, an expandable computer system of the invention includes a computer host and a docking station. The computer host has a first power connecting portion and a first peripheral component connecting portion. The docking station has a casing, a second power connecting portion and a second peripheral component connecting portion. The second power connecting portion and the second peripheral component connecting portion are disposed at the casing. When the computer host is disposed at the casing, the second power connecting portion is electrically connected to the first power connecting portion to transmit a power signal to the computer host, and the second peripheral component connecting portion is electrically connected to the first peripheral component connecting portion to transmit at least a peripheral component signal to the computer host or receive the peripheral component signal from the computer host.

According to a docking station and an expandable computer system of the invention, the computer host can be connected to the docking station. In this way, expansion ports of the docking station are used to expand connecting ports of the computer host further to decrease the volume of the computer host. Peripheral devices originally connected to the computer host can be connected to the docking station. Then, when a user wants to move the computer host to other places to use, he can go on to use the computer host without drawing out any connecting wires after he draws out the computer host and inserts the computer host to another docking station connected with another group of peripheral devices. The docking station of the invention also has a power connecting portion, and the power connecting portion can provide the computer host with electric power to facilitate the usage.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional computer host;

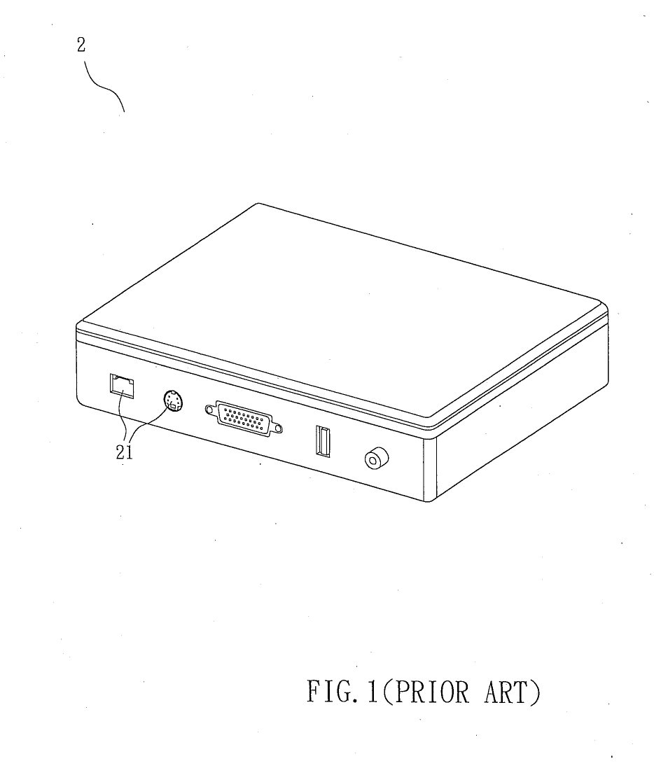

FIG. 2 is a schematic diagram showing a disassembled expandable computer system according to a preferred embodiment of the invention;

FIG. 3 is a schematic diagram showing an assembled expandable computer system according to a preferred embodiment of the invention;

FIG. 4 is a schematic diagram showing a disassembled expandable completer system according to another preferred embodiment of the invention;

FIG. 5 is a block diagram showing the expandable computer system in FIG. 2;

FIG. 6 is another block diagram showing the expandable computer system in FIG. 2; and

FIG. 7 is a schematic diagram showing a process of moving an expandable computer system according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

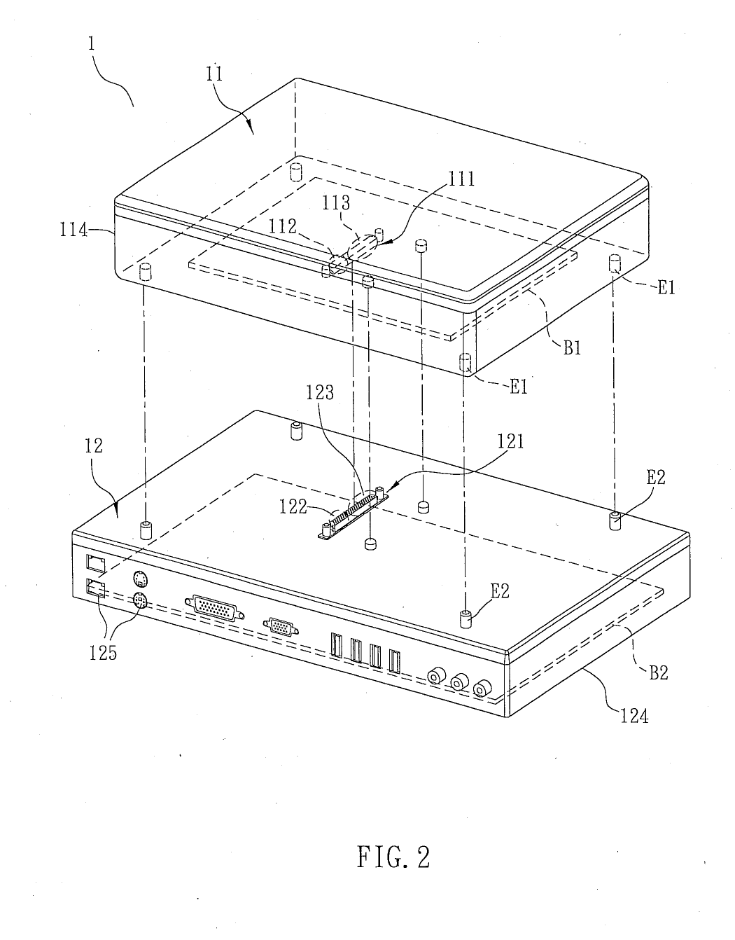

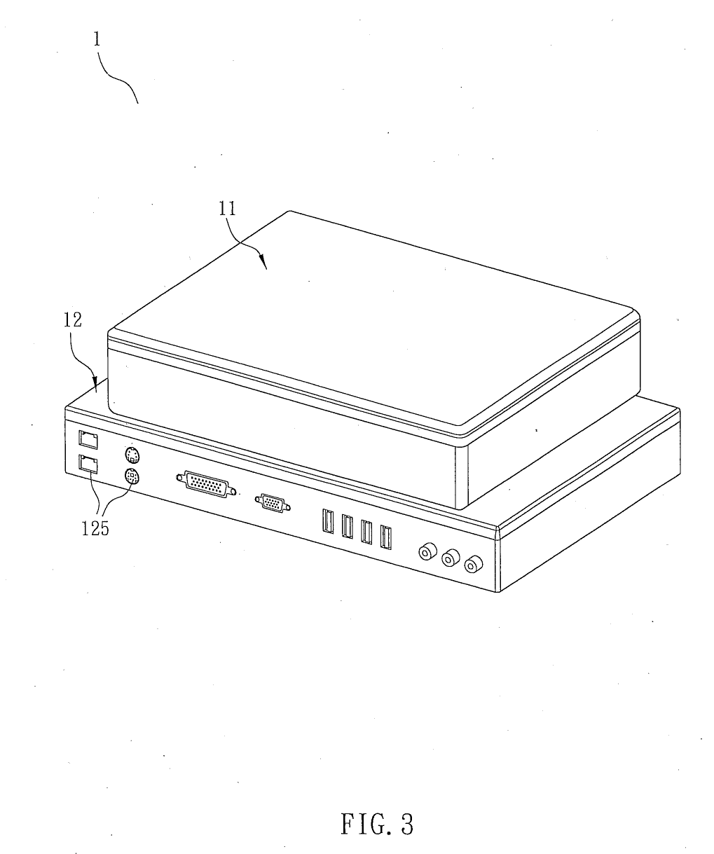

As shown in FIG. 2 and FIG. 3, an expandable computer system 1 of a preferred embodiment of the invention includes a computer host 11 and a docking station 12. FIG. 2 is a schematic diagram showing the computer host 11 and the docking station 12 which are separated; FIG. 3 is a schematic diagram showing the computer host 11 and the docking station 12 which are assembled.

The computer host 11 has a casing 114, a first power connecting portion 112 and a first peripheral component connecting portion 113. The first power connecting portion 112 and the first peripheral component connecting portion 113 are disposed at the casing 114. In the embodiment, each of the first power connecting portion 112 and the first peripheral component connecting portion 113 is formed by some pins of a first connecting port 111, and then the first power connecting portion 112 and the first peripheral component connecting portion 113 share the first connecting port 111. The first connecting port 111 may be electrically connected to a circuit board B1 in the computer host 11 and exposed outside the casing 114. In the embodiment, the first connecting port 111 is a male connector.

The docking station 12 has a casing 124, a second power connecting portion 122 and a second peripheral component connecting portion 123. The second power connecting portion 122 and the second peripheral component connecting portion 123 are disposed at the casing 124. In the embodiment, each of the second power connecting portion 122 and the second peripheral component connecting portion 123 is formed by some pins of a second connecting port 121, and then the second power connecting portion 122 and the second peripheral component connecting portion 123 share the second connecting port 121. The second connecting port 121 may be electrically connected to a circuit board B2 in the docking station 12 and exposed outside the casing 124. In the embodiment, the second connecting port 121 is a female connector.

When the computer host 11 is disposed at the casing 124 of the docking station 12, the second power connecting portion 122 is connected to the first power connecting portion 112 to transmit a power signal to the computer host 11, and the second peripheral component connecting portion 123 is connected to the first peripheral component connecting portion 113 to transmit at least a peripheral component signal to the computer host 11 or receive the peripheral component signal from the computer host 11. The casings 114 and 124 of the computer host 11 and the docking station 12 may have auxiliary fixing structures E1 and E2, respectively, to enhance the structural strength after the computer host 11 and the docking station 12 are connected. In the embodiment, the auxiliary fixing structure E1 on the computer host 11 is, for example, a recessed portion, the auxiliary fixing structure E2 on the docking station 12 is, for example, a protrudent portion, and the auxiliary fixing structures E1 and E2 can be connected with each other.

The bus technology used by the first connecting port 111 and the second connecting port 121 is not limited in the embodiment. In one embodiment, the first connecting port 111 and the second connecting port 121 may implement one or more instances of an interface such as Peripheral Component Interface Express (PCI-Express), although it is contemplated that any suitable interface standard or combination of standards may be employed. For example, in some embodiments the first connecting port 111 and the second connecting port 121 may be configured to implement a version of Universal Serial Bus (USB) protocol or IEEE 1394 (Firewire) protocol or other protocols regarding to interface that developed in the future in addition to or instead of PCI-Express.

Shapes and sizes of the computer host 11 and the docking station 12 in the embodiment are not limited. The computer host 11 may be a bare system or a minicomputer, and in the embodiment, the computer host 11 having a small volume is taken as an example.

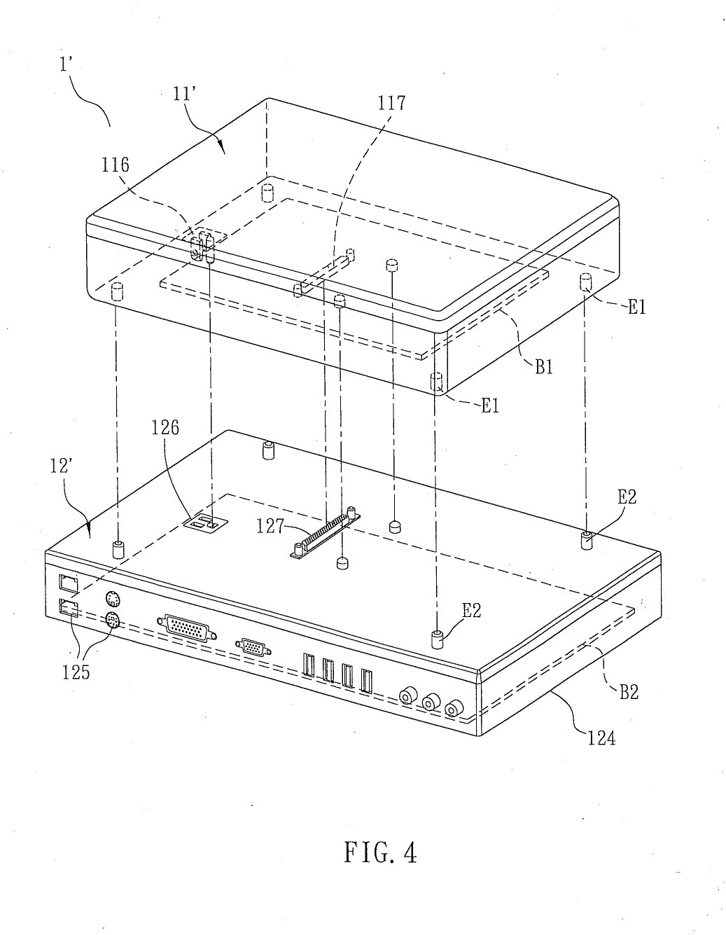

FIG. 4 is a schematic diagram showing another expandable computer system 1′ of the embodiment. The expandable computer system 1′ includes a computer host 11′ and a docking station 12′. The differences between the computer system 1′ and the computer system 1 of the above embodiment are that a first power connecting portion 116 and a first peripheral component connecting portion 117 of the computer host 11′ of the computer system 1′ are different connecting ports; a second power connecting portion 126 and a second peripheral component connecting portion 127 of the docking station 12′ are different connecting ports. When the computer host 11′ is disposed at the casing of the docking station 12′, the second power connecting portion 126 is connected to the first power connecting portion 116 to transmit a power signal to the computer host 11′, and the second peripheral component connecting portion 127 is connected to the first peripheral component connecting portion 117 to transmit at least one peripheral component signal to the computer host 11′. Herein, the types of the first power connecting portion 116 and the second power connecting portion 126 are not limited. For example, the first power connecting portion 116 and the second power connecting portion 126 may be common three prong power ports or universal serial bus (USB) connecting ports.

As shown in FIG. 2, the docking station 12 further has at least an expansion port 125. The docking station 12 having a plurality of expansion ports 125 is taken as an example in FIG. 2. The expansion ports 125 are disposed at and exposed outside the casing 121, and then a user can insert computer peripheral devices such as a keyboard, a mouse, an earphone, a network cable and a power wire into the expansion ports 125. The expansion ports 125 may be a USB connecting port, a recommended standard-232 (RS-232) connecting port, a 1394 connecting port, a PS/2 connecting port, a network connecting port, a power port or other peripheral connecting ports. When the computer peripheral devices are connected to the expansion ports 125, peripheral component signals can be transmitted to the computer host 11 via the second peripheral component connecting portion 122 and the first peripheral component connecting portion 112. Via the expansion ports 125, all the peripheral devices originally connected to the computer host 11 can be changed to be connected to the docking station 12 to enhance the mobility of the computer host 11.

The docking station 12 can further include at least an expansion interface card disposed in the casing 124 to enhance the whole performance. The expansion interface card is inserted in the circuit board B2, and common interface cards include a graphic card, a sound card, a network card, a hard disk control card and so on. The docking station 12 may also have a hard disk therein, and the hard disk is disposed in the casing 124 to expand the whole storage space.

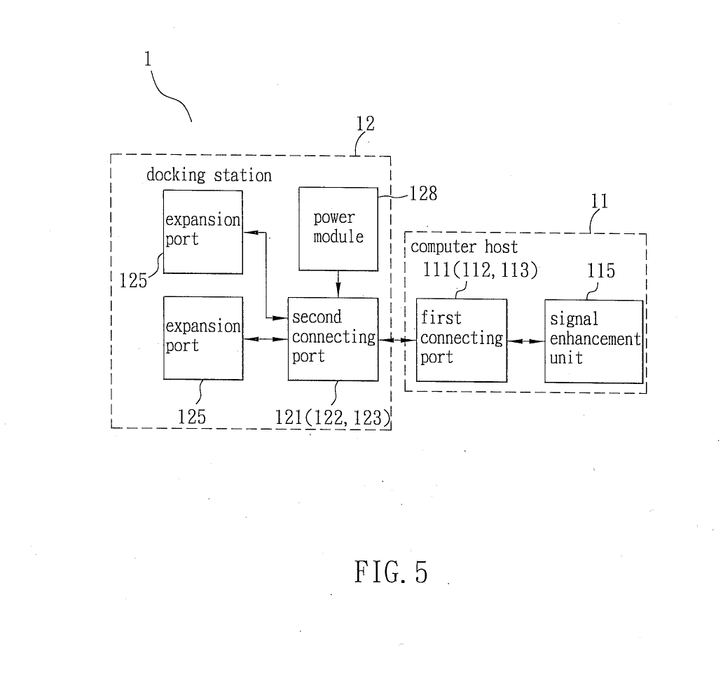

As shown in FIG. 2 and FIG. 5, FIG. 5 is a block diagram showing the expandable computer system 1 in FIG. 2. The mode of transmitting signals of the docking station 12 to the computer host 11 is illustrated hereinbelow. When the expansion port 125 transmits a peripheral component signal such as a USB signal to the second connecting port 121, the USB signal is transmitted to the circuit board B1 of the computer host 11 via the second peripheral component connecting portion 123 of the second connecting bolt 121 and the first peripheral component connecting portion 113 of the first connecting port 111, and then the USB signal is transmitted to a signal processing unit via the wiring of the circuit board B1 to be processed. Then, the process of transmitting signals is finished. The circuit board B1 of the computer host 11 may be provided with a signal enhancement unit 115 including a signal amplifier, and the signal enhancement unit 115 can enhance the peripheral component signals transmitted from the docking station 12.

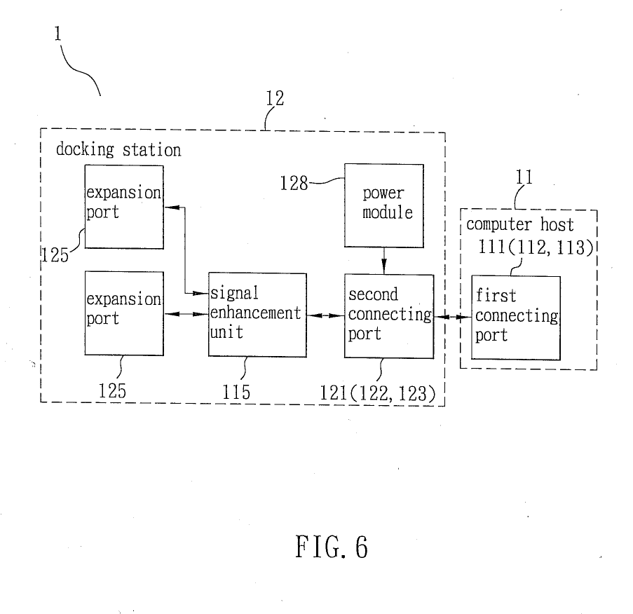

As shown in FIG. 2 and FIG. 6, FIG. 6 is another block diagram showing the expandable computer system 1 in FIG. 2. The mode of transmitting signals of the docking station 12 to the computer host 11 is illustrated hereinbelow. The signal enhliancement unit 115 can also be disposed at the docking station 12 and be connected to the expansion ports 125 and the second connecting port 121. When the expansion port 125 transmits a peripheral signal such as a USB signal, after the USB signal is amplified by the signal enhancement unit 115, the USB signal is transmitted to the circuit board B1 of the computer host 11 via the second peripheral component connecting portion 123 of the second connecting port 121 and the first peripheral component connecting portion 113 of the first connecting port 111.

As shown in FIG. 6, the docking station 12 may further ha a power module 128 electrically connected to the second power connecting portion 122 of the second connecting port 121. The power module 128 can receive external electric power or use electric power stored in the power module 128 to transmit or supply a power signal. The power signal is transmitted to the computer host 11 via the second power connecting portion 122 of the second connecting port 121 and the first power connecting portion 112 of the first connecting port 111. In this way, the computer host 11 can operate without connecting the power wire, and therefore, the mobility of the computer host 11 increases.

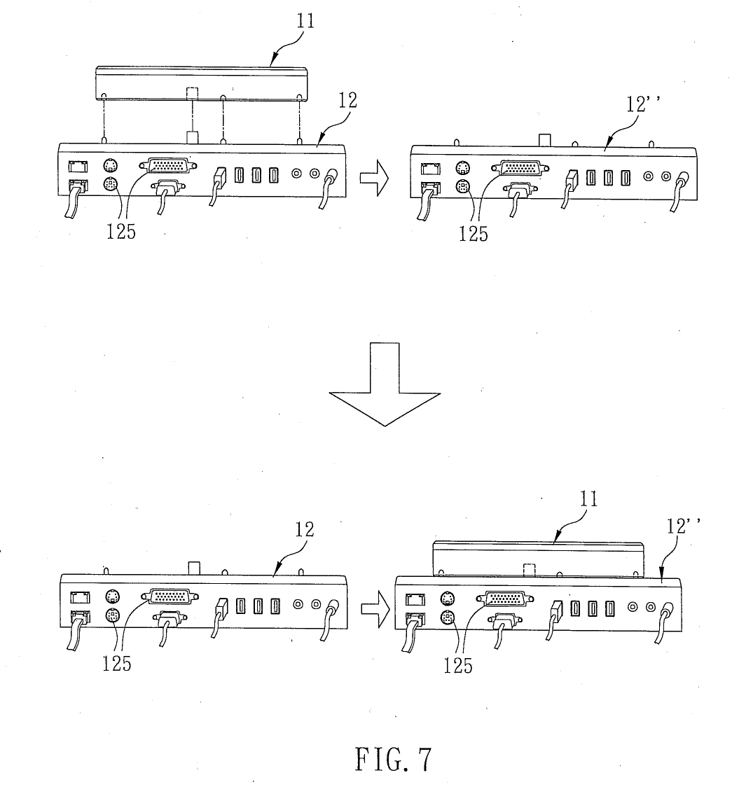

As shown in FIG. 7, the mobility of the computer host 11 of the embodiment is illustrated. The docking station 12 is located at one place such as a parlor, another docking station 12″ is located at another place such as a room, and both the docking stations 12 and 12″ are connected with computer peripheral devices such as mice, earphones, power wires and keyboards. When a user wants to move the computer host 11 from the parlor to the room, he only needs to draw out the computer host 11 and inserts the computer host 11 to the docking station 12″ in the room to go on to use the computer host 11 in the room without drawing out the connection wires of the peripheral devices.

To sum up, the docking station and the expandable computer system of the invention allow the computer host to be connected to the docking station. In this way, the expansion ports of the docking station can be used to expand the connecting ports of the computer host further to decrease the volume of the computer host. The peripheral devices originally connected to the computer host can be connected to the docking station. In this way, when the user wants to move the computer host to other places to use, he can go on to use the computer host without drawing out any connecting wires after he directly draws out the computer host and inserts the computer host to another docking station connected with another group of peripheral devices. The docking station of the invention also has the power connecting portion, and the power connecting portion can provide the computer host with electric power to facilitate the usage.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A docking station for cooperating with a computer host having a first power connecting portion and a first peripheral component connecting portion, the docking station comprising:
a casing for disposing the computer host;
a second power connecting portion disposed at the casing; and
a second peripheral component connecting portion disposed at the casing,
wherein when the computer host is disposed at the casing, the second power connecting portion is electrically connected to the first power connecting portion to transmit a power signal to the computer host, and the second peripheral component connecting portion is electrically connected to the first peripheral component connecting portion to transmit at least a peripheral component signal to the computer host or receive the peripheral component signal from the computer host.

2. The docking station according to claim 1 further comprising:
a power module electrically connected to the second power connecting portion to provide the power signal.

3. The docking station according to claim 1 farther comprising:
at least an expansion port disposed at the casing, wherein the expansion port is electrically connected to the second peripheral component connecting portion to transmit or receive the peripheral component signal.

4. The docking station according to claim 3, wherein the expansion port is a universal serial bus (USB) connecting port, a recommended standard-232 (RS-232) connecting port or a 1394 connecting port.

5. The docking station according to claim 1 further comprising:
at least an expansion interface card disposed in the casing, wherein the peripheral component signal is transmitted from the expansion interface card to the computer host via the second peripheral component connecting portion.

6. The docking station according to claim 5, wherein the expansion interface card is a graphic card, a sound card, a network card or a hard disk control card.

7. The docking station according to claim 1 further comprising:
an expansion hard disk disposed in the casing, wherein the peripheral component signal is transmitted from the expansion hard disk to the computer host via the second peripheral component connecting portion.

8. The docking station according to claim 1, wherein the computer host comprises a first connecting port comprising the first power connecting portion and the first peripheral component connecting portion.

9. The docking station according to claim 8, wherein the casing comprises a second connecting port comprising the second power connecting portion and the second peripheral component connecting portion.

10. The docking station according to claim 9, wherein each of the first connecting port and the second connecting port is a peripheral component interface-express (PCI-E) connecting port.

11. The docking station according to claim 1, wherein the first power connecting portion is a connecting port, and the first peripheral component connecting portion is another connecting port.

12. The docking station according to claim 11, wherein the second power connecting portion is a connecting port for connecting the first power connecting portion, and the second peripheral component connecting portion is another connecting port for connecting the first peripheral component connecting portion.

13. An expandable computer system comprising:
a computer host having a first power connecting portion and a first peripheral component connecting portion; and
a docking station having a casing, a second power connecting portion disposed at the casing and a second peripheral component connecting portion disposed at the casing, wherein when the computer host is disposed at the casing, the second power connecting portion is electrically connected to the first power connecting portion to transmit a power signal to the computer host, and the second peripheral component connecting portion is electrically connected to the first peripheral component connecting portion to transmit at least a peripheral component signal to the computer host or receive the peripheral component signal from the computer host.

14. The expandable computer system according to claim 13, wherein the docking station further comprises a power module electrically connected to the second power connecting portion to provide the power signal.

15. The expandable computer system according to claim 13, wherein the docking station further comprises at least an expansion port disposed at the casing, wherein the expansion port is electrically connected to the second peripheral component connecting portion to transmit or receive the peripheral component signal.

16. The expandable computer system according to claim 15, wherein the expansion port is a USB connecting port, a RS-232 connecting port or a 1394 connecting port.

17. The expandable computer system according to claim 13, wherein the docking station further comprises at least an expansion interface card disposed in the casing, and the peripheral component signal is transmitted from the expansion interface card to the computer host via the second peripheral component connecting portion.

18. The expandable computer system according to claim 17, wherein the expansion interface card is a graphic card, a sound card, a network card or a hard disk control card.

19. The expandable computer system according to claim 13, wherein the docking station further comprises an expansion hard disk disposed in the casing, and the peripheral component signal is transmitted from the expansion hard disk to the computer host via the second peripheral component connecting portion.

20. The expandable computer system according to claim 13, wherein the computer host comprises a first connecting port comprising the first power connecting portion and the first peripheral component connecting portion.

21. The expandable computer system according to claim 20, wherein the docking station further comprises a second connecting port comprising the second power connecting portion and the second peripheral component connecting portion.

22. The expandable computer system according to claim 21, wherein each of the first connecting port and the second connecting port is a PCI-E connecting port.

23. The expandable computer system according to claim 13, wherein the first power connecting portion is a connecting port, and the first peripheral component connecting portion is another connecting port.

24. The expandable computer system according to claim 23, wherein the second power connecting portion is a connecting port for connecting the first power connecting portion, and the second peripheral component connecting portion is another connecting port for connecting the first peripheral component connecting portion.

25. The expandable computer system according to claim 13, wherein the computer host has a signal enhancement unit for enhancing the peripheral component signal.

26. The expandable computer system according to claim 25, wherein the docking station has a signal enhancement unit for enhancing the peripheral component signal.
